(19) United States
(12) Patent Application Publication
(10) Pub. No.: US 2006/0122820 A1
(43) Pub. Date: Jun. 8, 2006

(54) Scripting language for domain-specific modification of a simulation model

(75) Inventors: Frederick P. Wieland, Reston, VA (US); Frederick S. Kuhl, Oak Hill, VA (US); Michael J. White, Sterling, VA (US)

Correspondence Address: STERNE, KESSLER, GOLDSTEIN & FOX PLLC, 1100 NEW YORK AVENUE, N.W., WASHINGTON, DC, 20005, US

(73) Assignee: The MITRE Corporation, McLean, VA (US)

(21) Appl. No.: 11/002,432

(22) Filed: Dec. 3, 2004

(51) Int. Cl. G06F 9/45

(52) U.S. Cl. 703/22

(57) ABSTRACT

A scripting language enables a systems analyst to write one or more scripts to manage the behavior of a simulation model, without having detailed knowledge of the programming language or the software architecture of the simulation model. Script specifications define the simulation procedures that the underlying simulation model expects to be present. Script definitions are prepared to change different purposes or behaviors of the simulation model. The script definitions and script specifications are matched and translated to generate a simulation code sequence. The simulation code sequence is combined with the simulation code representing the underlying simulation model. During the combination, the structure or behavior of the simulation model is manipulated or changed by commands or procedures introduced by the script-based simulation code sequence.

### COPYRIGHT NOTICE

A portion of the disclosure of this patent document contains material which is subject to copyright protection. The copyright owner has no objection to the facsimile reproduction by anyone of the patent document or patent disclosure, as it appears in the Patent and Trademark Office patent files or records, but otherwise reserves all copyright rights whatsoever.

### BACKGROUND OF THE INVENTION

1. Field of the Invention

The present invention relates generally to a scripting language, and more specifically, to a scripting language for generating an executable script for a computer-implemented process.

2. Related Art

A simulation model can be developed to imitate real-world processes or systems over a period of time. The simulation model is based on a set of assumptions concerning the operations of the imitated system. A systems analyst generally runs a simulation to predict or study the behavior of the imitated system as it is influenced by the set of assumptions. By developing or changing the simulation model to study the effects of alternative assumptions, a systems analyst can test and evaluate various system designs and operations without incurring the expense of constructing a real model. Therefore, a simulation model can be a cost-effective tool in operations research and systems analysis

Conventionally, a simulation model relies on some form of data file manipulation in conjunction with actual modification of source code to effect structural changes. To modify a simulation model to test alternative system designs or operations, the systems analyst must be skilled in the programming language used to develop the simulation model and/or must understand the software architecture of the simulation model. Otherwise, the systems analyst must rely on a software developer to modify the simulation model.

Furthermore to modify a conventional simulation model, it is necessary to conduct manual analyses of the impacts of alternative designs or operations. Data must be collected and validated to test the accuracy and confidence level of any structural modifications to the model. As a result, the cycle time is significantly long for designing, developing, and testing simulations of alternative system designs or operations.

Therefore, a need exists for a technology that addresses these concerns and allows a systems analyst to more efficiently conduct simulation studies.

### SUMMARY OF THE INVENTION

The scripting language of the present invention enables a systems analyst to write one or more scripts to manage the behavior of a simulation model. The simulation model can imitate any type of domain, including, without limitation, an air traffic control domain, manufacturing domain, logistics domain, biomedical domain, defense domain, or the like.

The scripting language permits “domain-specific” modifications of a simulation model, which has been developed for a specific domain. The systems analyst can write one or more domain-specific scripts to directly manipulate the internal logic of the simulation model, without having detailed knowledge of the programming language or the software architecture of the simulation model.

In an embodiment, a set of script specifications defines the simulation procedures that the underlying simulation model expects to be present, and which the systems analyst can modify or replace. The script specifications establish the script boundaries, and define the inputs and outputs of the script. An embodiment also contains a set of default script definitions, which the model will use in default of the systems analyst's supplying modified or replacement scripts

Script definitions are prepared by a systems analyst to change different purposes or behaviors of the simulation model. As the systems analyst considers the script specifications, the systems analyst decides whether to employ the default script definition corresponding to each script specification, or to supply an alternative definition that represents different behavior.

The script definitions (either the default or analyst-supplied script definitions) are matched with the script specifications. If successfully matched, the script definitions and script specifications are translated or interpreted to generate a sequence of simulation code. Each sequence of simulation code corresponds to a distinct script (i.e., matched script definition(s) and script specification(s) for managing a particular simulation behavior).

One or more sets of simulation code sequences are combined with the simulation code representing the underlying simulation model. During the combination process, the structure or behavior of the simulation model is manipulated or changed by commands or procedures introduced by the script-based simulation code sequences. The resulting combination is compiled into executable code for running the simulation.

The scripting language of the present invention allows non-simulation experts to modify the behavior of the simulation model, without having to wait for lengthy development updates from software developers. The present invention shortens the analysis cycle time, makes simulations more user-friendly, and allows results to be generated faster such that the results would be more useful to the end-user analyst.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable one skilled in the pertinent art(s) to make and use the invention. In the drawings, generally, like reference numbers indicate identical or functionally or structurally similar elements. Additionally, generally, the leftmost digit(s) of a reference number identifies the drawing in which the reference number first appears.

FIG. 1 illustrates an operational flow for managing domain-specific behavior of a simulation model with a scripting language according to an embodiment of the present invention.

FIG. 2 illustrates a domain-specific scripting system according to an embodiment of the present invention.

FIG. 3 illustrates a hierarchical structure of a domain-specific script according to an embodiment of the present invention.

FIG. 4 illustrates a hierarchical structure of a formal argument according to an embodiment of the present invention.

FIG. 5 illustrates a hierarchical structure of a script body according to an embodiment of the present invention.

FIG. 6 illustrates a hierarchical structure of a statement expression according to an embodiment of the present invention.

FIG. 7 illustrates an operational flow for evaluating behavior changes to a simulation model according to an embodiment of the present invention.

FIG. 8 illustrates an example computer system useful for implementing portions of the present invention.

### DETAILED DESCRIPTION OF THE INVENTION

According to embodiments of the present invention, a scripting language enables a systems analyst to write one or more scripts to manage the behavior of a simulation model. A script represents a sequence of commands or procedures that are translated or interpreted, and thereafter executed by a software program, which is compiled and run on a computer system. Thus, the scripting language of the present invention is adapted for writing a script that is translated or interpreted to modify the structure of a simulation model. The simulation model can imitate any type of domain, including, without limitation, an air traffic control domain, manufacturing domain, logistics domain, biomedical domain, defense domain, or the like.

In an embodiment, the scripting language of the present invention permits “domain-specific” modifications of a simulation model without requiring a “general-purpose” modification to the simulation model. To implement a general-purpose modification, a systems analyst must understand the detailed software architecture of the simulation model, its various software classes and subclasses, and, if the simulation model is object-oriented, the object class hierarchy.

The scripting language of the present invention enables the building of a simulation model (and constructs for modifying the behavior of a simulation model) that is specific to the domain for which the simulation model is targeted. As such, the scripting language enables a complex simulation model to be modified by a systems analyst having an appropriate level of knowledge in the particular domain. The systems analyst is not required to be proficient in the programming language used to develop the underlying simulation model. For example, a simulation model can be developed with the C/C++ programming language, GPSS programming language, GPSS/V programming language, GPSS/H programming language, Simulation Language with Extensibility (SLX) software available from Wolverine Software Corporation (Alexandria, VA), or the like. The systems analyst can write one or more scripts to directly manipulate the internal logic of, for example, an SLX-based simulation model, without having detailed knowledge of the SLX programming language or the software architecture of the SLX-based simulation model.

The scripting language of the present invention allows non-simulation experts to modify the underlying structure of the simulation model, without having to wait for lengthy development updates from software producers. The present invention shortens the analysis cycle time, makes simulations more user-friendly, and allows results to be generated faster such that the results would be more useful to the end-user analyst.

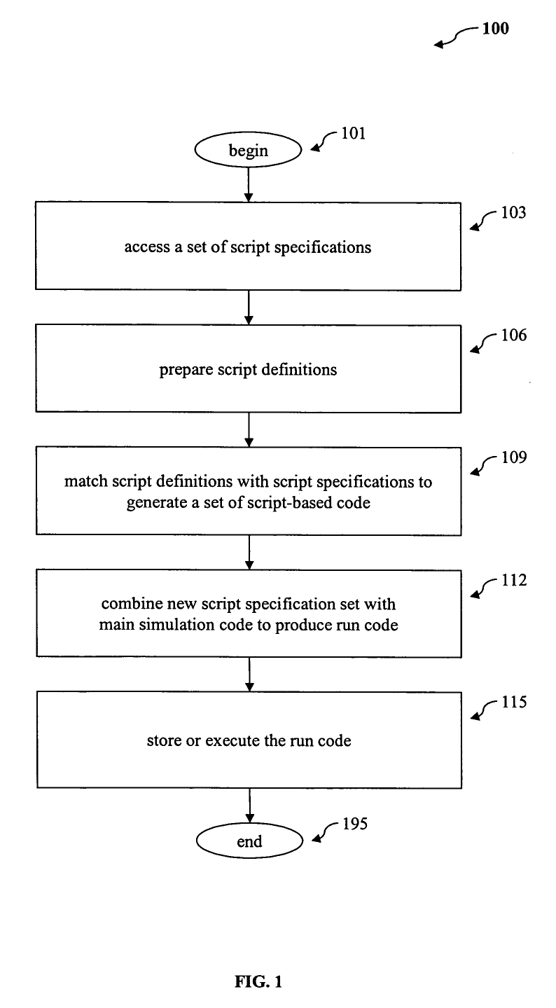

Referring to FIG. 1, flowchart 100 represents the general operational flow of an embodiment of the present invention. More specifically, flowchart 100 shows an example of a control flow for managing the behavior of a simulation model with a domain-specific scripting language.

The control flow of flowchart 100 begins at step 101 and passes immediately to step 103. At step 103, a set of script specifications are accessed. The script specifications are a function of the underlying simulation model and define the simulation procedures that the underlying simulation model expects to be present. The script specifications establish the script boundaries, and define the inputs and outputs of an existing simulation model, which has been developed for a specific domain (e.g., air traffic control domain). The script specifications can include declarations, parameters, or the like that can be changed or completed by a systems analyst having an appropriate background and experience in the specific domain.

At step 106, the systems analyst prepares one or more script definitions that are based on the scripting language of the present invention. The systems analyst writes script definitions for different scripts to change different purposes or behaviors on the simulation model. While the systems analyst writes the script definitions, the systems analyst decides whether to accept the default definitions of the script specifications (from step 103), or replace the default definitions. By replacing the default definitions, the systems analyst can alter the behavior of the simulation model within the boundaries set by the script specifications.

At step 109, the script definitions (from step 106) are matched with the script specifications (from step 103). In an embodiment, the script definitions are checked for errors, and the systems analyst is notified if errors are detected. If successfully matched, the script definitions and script specifications are translated or interpreted to generate a sequence of simulation code. Each sequence of simulation code corresponds to a distinct script (i.e., matched script definition(s) and script specification(s) for managing a particular simulation behavior) written with the scripting language of the present invention. Thus, a plurality of scripts (for modifying a plurality of simulation behaviors) are translated or interpreted to generate multiple sets of simulation code sequences.

At step 112, the one or more sets of simulation code sequences based on the scripting language (from step 109) are combined with the simulation code representing the underlying simulation model. During the combination process, the structure or behavior of the simulation model is manipulated or changed by commands or procedures introduced by the one or more sets of script-based simulation code sequences. The resulting combination is compiled into executable code for running the simulation.

At step 115, the executable code is stored to memory and/or executed to run the simulation. Afterwards, the control flow ends as indicated at step 195.

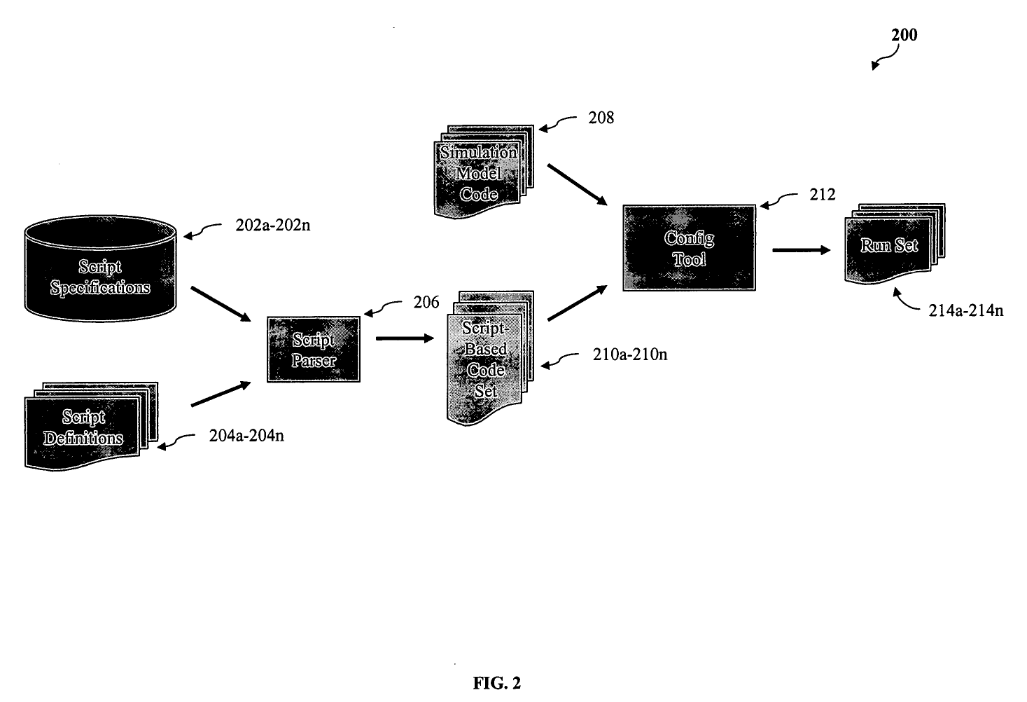

FIG. 2 illustrates an embodiment of a domain-specific scripting system 200 that is useful for implementing various aspects of the present invention, including the control flow of flowchart 100. Scripting system 200 includes a plurality of script specifications 202a-202n, a plurality of script definitions 204a-204n, a script parser 206, a set of simulation code 208 representing a simulation model, a plurality of script-based simulation code sequences 210a-210n, a configuration tool 212, and a set of simulation executable code 214a-214n.

Script specifications 202a-202n include the script specifications described above at step 103. Script specifications 202 can be stored in a database management system, read from any other memory location (i.e., main memory, hard disk, removable storage medium, etc.), or the like.

Script definitions 204a-204n include the one or more script definitions (based on the scripting language of the present invention) that are translated to modify the behavior(s) of the underlying simulation model. A text editor, graphical user interface, or the like is used to enable the systems analyst to prepare script definitions 204a-204n.

Script parser 206 ensures script definitions 204a-204n match script specifications 202a-202n. Script parser 206 also translates or interprets script definitions 204a-204n and script specifications 202a-202n to generate one or more sets of simulation code sequences 210a-210n.

Each simulation code sequence 210a-210n represents a distinct script (i.e., matched script definition(s) 204a-204n and script specification(s) 202a-202n) for managing a particular simulation behavior.

Simulation code 208 is developed to produce the underlying simulation model. Simulation code 208 can be written in any type of simulation or general-purpose programming language.

Configuration tool 212 combines and compiles simulation code 208 and simulation code sequences 210a-210n into simulation executable code 214a-214n that can be executed to run the simulation. The structure or behavior of the underlying simulation model (represented by simulation code 208) is manipulated or changed by commands or procedures introduced by simulation code sequences 210a-210n. Thus, configuration tool 212 creates data sets under the systems analyst's control.

Simulation executable code 214a-214n includes the code and data files needed for a simulation run. Simulation executable code 214a-214n can be stored to memory and/or executed to run the simulation.

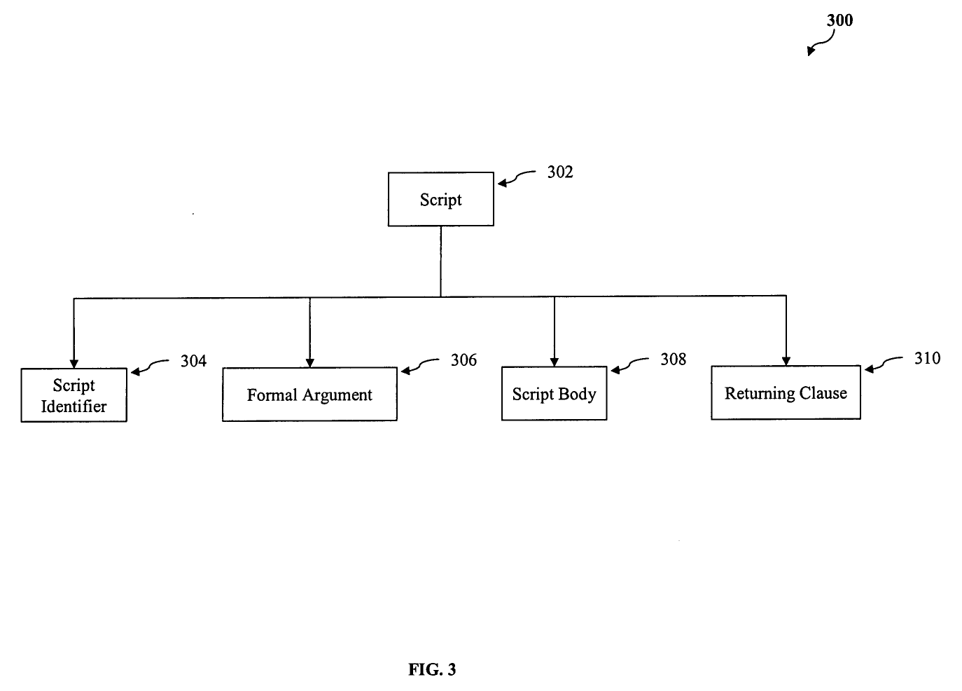

FIG. 3 illustrates a hierarchical structure 300 of an embodiment of the complex components or elements of the scripting language of the present invention. Hierarchical structure 300 includes a domain-specific script 302, a script identifier 304, a formal argument 306, a script body 308, and optionally, a Returning Clause 310.

Script 302 is the basic building block of the scripting language of the present invention. As discussed above with reference to FIG. 2, script 302 is generated from script specifications 202a-202n and script definitions 204a-204n, which collectively enable a systems analyst to define or alter the boundaries and behavior of the simulation model code 208. Script 302 is interpreted or translated into script-based simulation code 210a-210n, and linked or combined with the simulation model code 208. The simulation model code 208 can call some scripts 302 directly, and other scripts 302 can be called only by other scripts 302

Script 302 includes a script identifier 304, a formal argument 306, a script body 308, and optionally, a Returning Clause 310. Script identifier 304 allows each specification (e.g., script specifications 202a-202n) within a set to have a unique name. In an embodiment, script identifier 304 begins with a letter or underscore, and the following characters can be letters, digits, or underscores.

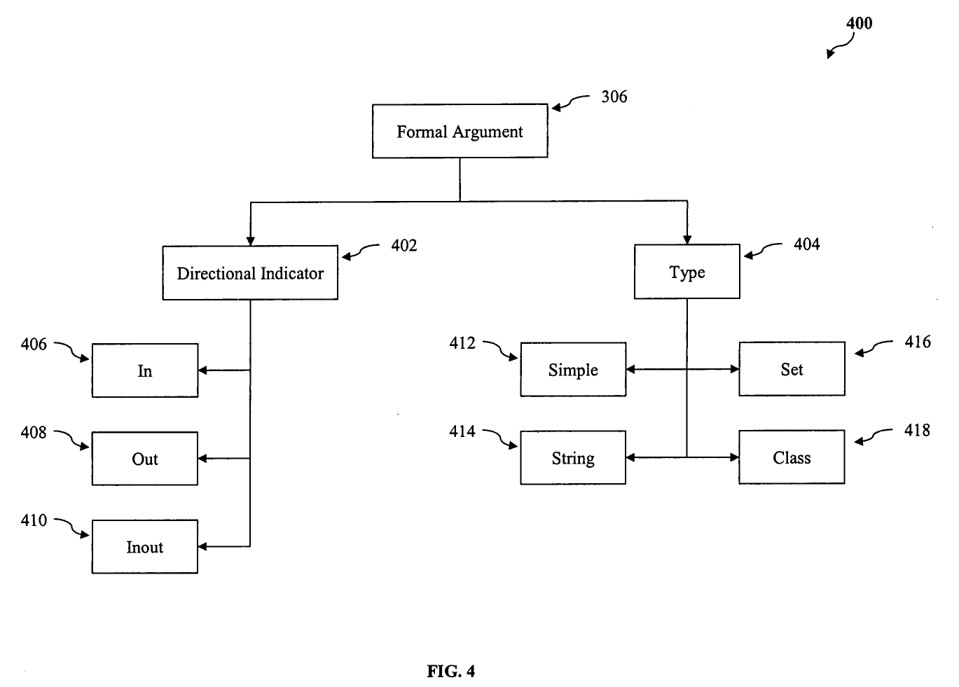

In an embodiment, script 302 takes zero or more formal arguments 306, separated by commas. Formal argument 306 specifies the formal parameters of script 302. FIG. 4 illustrates a hierarchical structure 400 of an embodiment of formal argument 306. As shown, formal argument 306 includes a directional indicator 402 and a type 404.

Directional indicator 402 is an optional component, and includes an In indicator 406, an Out indicator 408, and an Inout indicator 410. In indicator 406 specifies that a formal parameter would be read as input. Out indicator 408 specifies that a formal parameter would be read as output. Inout indicator 410 specifies that a formal parameter would be read as both input and output.

A type definition states the name of a particular type 404 and the procedures allowed for the particular type 404. A procedure on a type 404 may have formal parameters and may return a value.

Type 404 includes a simple type 412, a string type 414, a set type 416, and a class type 418. Simple type 412 includes integer, floating, double, Boolean, or the like. Simple type 412 and string type 414 can be considered as primitive types, with string type 414 being specified to read and/or write a fixed or known (e.g., “string(n)”) quantity of characters, or an indeterminate or generic (e.g., “string(*)”) quantity of characters. Set type 416 can be specified to read and/or write a predefined or known set (e.g., “set(classname)”) or generic set (e.g., “set(*)”).

In an embodiment, class type 418 is translated to a pointer-to-class type when script 302 is translated to simulation code 210a-210n. Thus, class type 418 is a simple identifier (e.g., “runway”) that is translated to a pointer-to-class type (e.g., “pointer(runway)”). The underlying simulation model (both simulation code 208 and script-based simulation code 210a-210n) uses a pointer-to-class types (e.g., “pointer(class_type)”). Pointer-to-class types represent complex types according to the present invention. Pointer-to-class types represent data structures rather than objects with complex behavior. In an embodiment, a pointer can represent all or some of a global data structure.

As discussed, formal argument 306 includes an optional direction indicator 402 and a type 404 followed by an identifier. In an embodiment, formal argument 306 takes the following form, expressed in the well-known Backus-Naur Form (|BNF|):

FormalArguments ::= [ FormalArgument ( , FormalArgument ) ]
FormalArgument ::= [ in | out | inout] ( SimpleArgType |
StringArgType | SetArgType | ClassArgType ) <identifier>
SimpleArgType ::= int | float | double | boolean
StringArgType ::= string ( ( * | <number> ) )
SetArgType ::= set ( ( * | <identifier> ) )
ClassArgType ::= <identifier> | *

The following is an example script 302 having the script identifier 304 (“argex”):

script argex(in int i, out double d, string(*) st, in set(runway)s) { . . . }

As can be seen in the above example, the script “argex” includes a formal argument 306 that specifies four formal parameters having the identifiers “i”, “d”, “st”, and “s”. The first identifier “i” is an integer as indicated by the simple argument type 412 (“int”), and is read as an input as indicated by the In directional indicator 406 (“in”). The second identifier “d” is a double type as indicated by the simple argument type 412 (“double”), and is read as output as indicated by the Out directional indicator 408 (“out”). The third identifier “st” is a generic string type as indicated by the string type 414 (“string(*)”). The fourth identifier “s” is a class type having the simple identifier “runway” as indicated by the class type 418 (“set(runway)”), and is read as input as indicated by the In directional indicator 406. The script body 308 for script “argex” is expressed by “{ . . . }”.

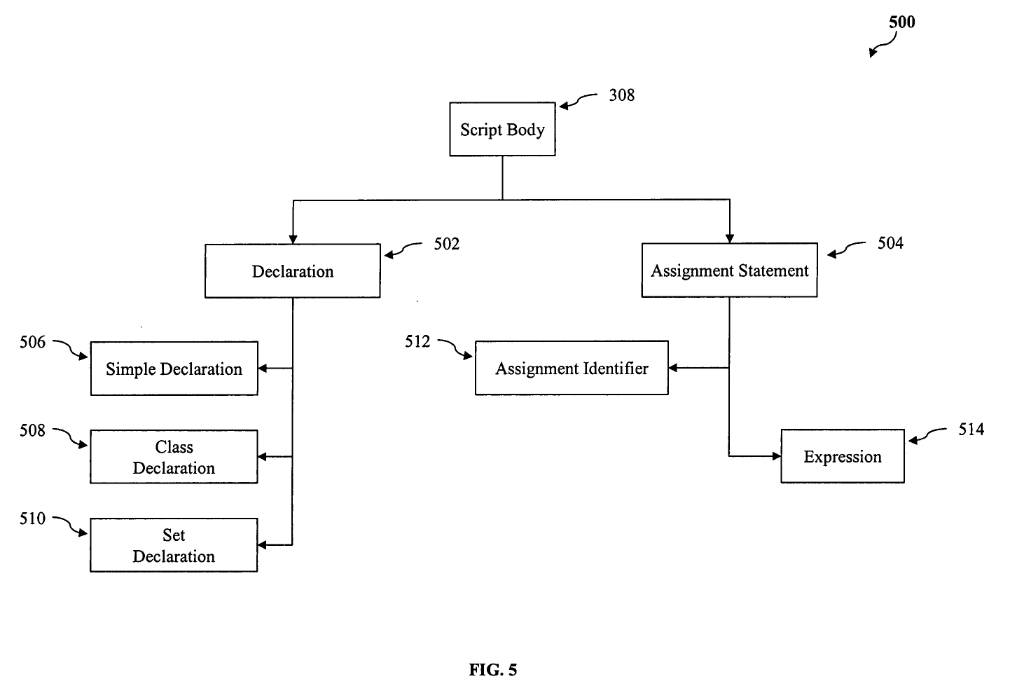

FIG. 5 illustrates a hierarchical structure 500 of a script body 308 according to an embodiment of the present invention. Script body 308 includes at least one declaration 502 and at least one assignment statement 504. Variables, aside from formal arguments 306, must be declared and initialized before use. All declarations 502 must precede any executable statement. Declarations 502 can take the form of a simple declaration 506, class declaration 508, or set declaration 510.

Simple declaration 506 can be declared as an integer, floating, double, Boolean, string(*), string(<number>), or the like. In an embodiment, simple declaration 506 takes the form “Declarator::=<identifier>[=<literal>],” where “<identifier>” is an unique name for the simple declaration 506, and “<literal>” contains the declaration statement. Examples of a simple declaration 506 include:

int a, b, c = 0, d = −1234;
float f = 0.0, g = 6.02e23;
double xx = −0.12e−34, yy;
boolean one = TRUE, two = FALSE;
sting(*) s1, s2;
string(123) s3 = “123”, s4 = “456”;
string(5) s5 = “aa\“bb”;

As can be noted, string literals are characters other than a double-quote, located between double quotes. A double quote can be included by escaping it with a backslash (e.g., “123” “A \“quote\””).

Integer literals are strings of digits, optionally preceded by a minus sign (e.g., 123 or −1776). Floating-point literals, used both for floating and double types, contain a decimal point, and may have an exponent (e.g., 0.1234, 12.56, 0.122E3, or 23.56e-66). Boolean literals are either TRUE or FALSE. Set literals do not exist.

Class declaration 508 enables a variable to be declared as a class type. In an embodiment, class declaration 508 takes the form “Declaration::=(<identifier> | *)<identifier>(, <identifier>)”, with an identifier (“<identifier>”) specifying a particular class, or an asterisk (“*”) specifying a generic class. Class variables cannot be initialized in a declaration. Examples of a class declaration 508 include:

stuff a_stuff, b_stuff;
* generic_stuff;

Set declaration 510 enables variables to be declared as a set type. In an embodiment, set declaration 510 takes the form “Declaration::=set(*|<identifier>) (, <identifier>)”, with an asterisk (“*”) specifying a generic set or an identifier (“<identifier>”) specifying a set of a known class. A class set can be declared as first-in-first-out (FIFO) or last-in-last-out (LIFO). Sets can be ranked on their attributes. In other words:

Declaration ::= set(<identifier>) [SetRanking] <identifier>
( ,<identifier>) ;
SetRanking ::= ranked [FIFO | LIFO] [(SetKey( , SetKey)* )]
SetKey ::= (ascending | descending) <identifier>

Examples of a set declaration 510 include:

set(*) s1, s2;
set(stuff) s3, s4;
set(thing) ranked FIFO s5;
set(thing) ranked (ascending whoosit, descending whatsit) s6, s7;

As discussed, any variable declaration 502 must precede any executable statements. Thus, script body 302 includes declaration(s) 502 and an executable statement(s). In an embodiment, an executable statement may be an assignment statement 504 (as shown in FIG. 5). In an embodiment, assignment statement 504 takes the form:

ScriptBody ::= ( Declaration )* ( Statement )*
Statement ::= AssignmentStatement

An assignment statement 504 includes an assignment identifier 512 and an expression 514. In an embodiment, assignment statement 604 takes the form:

AssignmentStatement::=<identifier>=<expression>;

An assignment statement 504 cannot be embedded in an expression 514. Assignment identifier 512 must be a formal parameter that is declared by an “Inout” or “Out” directional indicator 402, or by a declaration 502. The type of the assignment identifier 512 must be appropriate to the type of the expression 514.

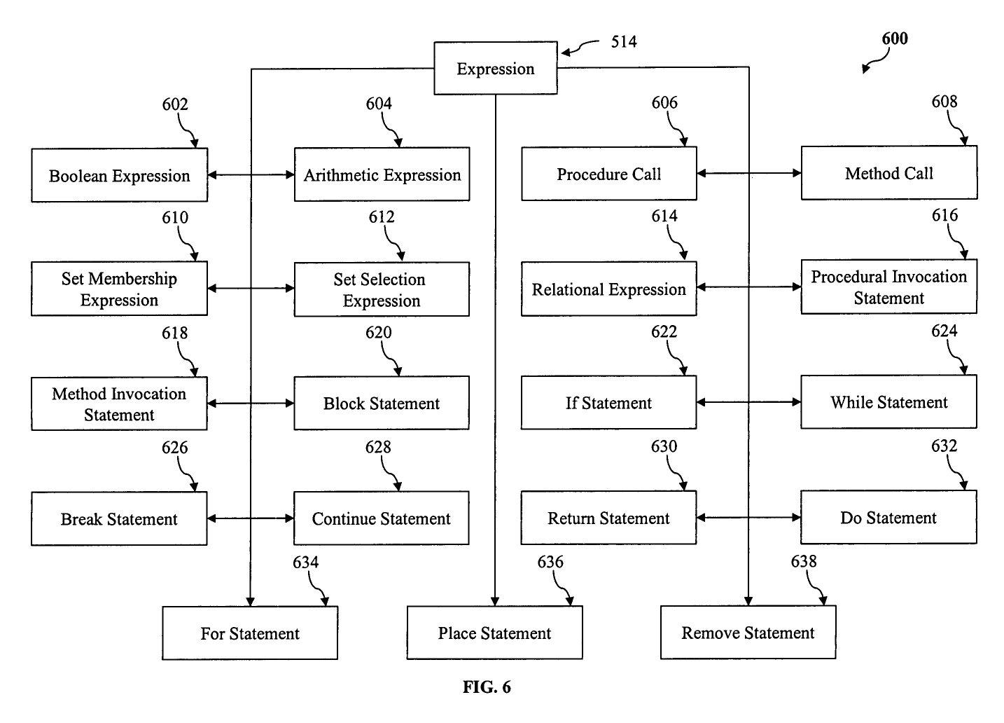

FIG. 6 illustrates a hierarchical structure 600 of expression 514 according to an embodiment of the present invention. Expression 514 includes a Boolean expression 602, arithmetic expression 604, procedure call 606, method call 608, set membership expression 610, set selection expression 612, relational expression 614, procedural invocation statement 616, method invocation statement 618, block statement 620, If statement 622, While statement 624, break statement 626, continue statement 628, return statement 630, Do statement 632, For statement 634, place statement 636, and remove statement 638.

Boolean expression 602 is formed by combining Boolean literals or variables with the unary “not” or binary “and” or “or” operators. The “not” operator takes precedence over the “and” operator, and the and” operator take precedence over the “or” operator. Both the “and” and “or” operators are left-associative, and are conditional. Boolean expression 602 may be parenthesized. Examples of Boolean expression 602 include:

boolean a = TRUE, b = FALSE, c;
c = a;
c = not a;
c = a and b;
c = a and b or TRUE and a;
c = (a and a) or (not c);

Arithmetic expression 604 is formed from numeric literals, variables, “+”, “−”, “*”, “/” and “%” (modulus) with the standard rules of precedence and associativity. Arithmetic expression 604 may be parenthesized. Examples of arithmetic expression 604 includes:

int i = 0, j;
float f = 1.0, g = 0.1234e56, h;
h = −i;
h = 2.0 * f / g;
h = f − 3.0 + g;
h = 3.0 + j * f;
j = (i + h) / g;

Boolean expression 602 and/or arithmetic expression 604 can contain a procedure call 606 and/or a method call 608. Procedure call 606 includes an identifier (i.e., the procedure name), opening parenthesis, optional arguments, and closing parenthesis. The optional arguments are statement expressions. In an embodiment, procedure call 606 takes the form:

ProcedureCall ::= <identifier> ( Arguments )
Arguments ::= Expression ( , Expression )*

Method call 608 is a procedure call 606 prefixed with an identifier (which must have a class type 418) and a dot operator. In an embodiment, method call 608 takes the form:

MethodCall::=<identifier>. ProcedureCall

A method call 608 cannot be chained (e.g., “obj.p1( ).p2( )” is not allowed).

Boolean expression 602 can contain a set membership expression 610. A set membership expression 610 tests whether an identifier (representing a variable of class type 418) is or is not contained in a set. In an embodiment, set membership expression 610 takes the form:

MembershipExpression ::= (<identifier1> ( is_in | is_not_in )
<identifier2>) | ( <identifier2> contains <identifier1> )

In the above set membership expression 610, “<identifier1>” represents a variable of class type 418, and “<identifier2>” represents a variable of set type 416.

Examples of set membership expression 610 include:

airport a1, a2;
set (airport) s1, s2;
boolean b;
b = a1 is_in s1;
b = a2 is_not_in s2;
b = s1 contains a1;

Arithmetic expression 604 can contain a set selection expression 612. Set selection expression 612 allow selection of the first or last element of a set, the predecessor or successor of an element of a set, or retrieval of a ranked set based on retrieval keys. In an embodiment, set selection expression 612 takes the form:

SetSelectionExpression ::= ( first | last) ( ( <classname> | * ) ) in
RestrictedExpression

where “<classname>” is an identifier representing the name of a class (i.e., having class type 418), and the “RestrictedExpression” is an expression (e.g., identifier, procedure call, method call) representing a set (i.e., having set type 416). In another embodiment, set selection expression 612 takes the form:

SetSelectionExpression ::= ( predecessor | successor)
( RestrictedExpression ) in RestrictedExpression

where the first “RestrictedExpression” represents an object of the set's type and the second “RestrictedExpression” represents the set (i.e., having set type 416). In another embodiment, set selection expression 612 takes the form:

SetSelectionExpression ::= retrieve <classname>
( <attributename> = ArithmeticExpression ( , <attributename> =
ArithmeticExpression )* ) from RestrictedExpression

where “<classname>” is an identifier representing the name of a class (i.e., having class type 418), “<attributename>” is an identifier representing the name of a retrieval key defined for the set (having set type 416), and the “RestrictedExpression” yields a set with the proper keys defined.

Examples of set selection expression 612 include:

int i = 6, j = 7;
airport a1, a2;
other_object o1;
set (airport) s1, s2;
set (*) s3;
boolean b;
a1 = first (airport) in s1;
a1 = last (*) in o1.method_returning_set( );
a2 = position (i * 2) in s2;
a1 = predecessor (a1) in s1;
a2 = successor (a2) in s2;
a1 = retrieve airport (name=“DEN”,type=3) from s1;

Arithmetic expression 604 can be combined in a Boolean relational expression 614. In an embodiment, relational expression 614 takes the form:

RelationalExpression ::= ArithmeticExpression
RelationalOperator ArithmeticExpression
RelationalOperator :: = < | < = | = = | ! = | > = | >

Examples of relational expression 614 include:

int i = 0, j;
float f = 1.0, g = 0.1234e56, h;
boolean b;
b = 2.0 * f / g < f − 3.0 + g;
b = 3.0 + j * f = = (i + h) / g;

A procedural invocation statement 616 can be called independent of a Boolean expression 602 or arithmetic expression 604. In an embodiment, procedural invocation statement 616 takes the form:

ProcedureInvocationStatement::=ProcedureCall;

A method invocation statement 618 can also be called independent of a Boolean expression 602 or arithmetic expression 604. In an embodiment, method invocation statement 618 takes the form:

MethodInvocationStatement::=MethodCall;

A block statement 620 is a group of zero or more statements enclosed in braces (“{ . . . }”). In an embodiment, block statement 620 takes the form:

Block::={(Statement)*}

An If statement 622 includes a basic branch, zero or more ElseIf clauses, and an optional Else clause. The basic branch is the keyword “if”, a Boolean expression 602 or a relational expression 614 enclosed in parentheses, and a statement. The statement is executed only if the expression is TRUE.

An ElseIf clause includes the keywords “else” and “if”, a Boolean expression 602 or a relational expression 614 enclosed in parentheses, and a statement. The statement is executed if the expression in the basic branch, and all expressions preceding the ElseIf clause, are FALSE, and the expression in the ElseIf clause, itself, is TRUE.

An Else clause includes the keywords “else”, a Boolean expression 602 or a relational expression 614 enclosed in parentheses, and a statement. The statement is executed if the expression in the basic branch, and all expressions preceding the Else clause, are FALSE.

In an embodiment, If statement 622 takes the form:

IfStatement ::= if ( Expression ) Statement ( else if ( Expression )
Statement )* [ else ( Expression ) Statement ]

Examples of If statement 622 include:

```
if (f > g) f = g;
if (g <= f) {
  h = −i;
}
if (b and i == j) {
  h = 3.0 + j * f;
  if (j < 2) {
    j = (i + h) / g;
  }
  else if (b) j = 0;
  else if (h == 2.1) i = 0;
  else {
    j = 1;
  }
}
```

While statement 624 includes the keyword “while”, a Boolean expression 602 or a relational expression 614 enclosed in parentheses, and a statement. The statement is executed repeatedly while the expression is TRUE.

In an embodiment, While statement 624 takes the form:

WhileStatement::=while (Expression) Statement

An example of While statement 624 includes:

```
while (g <= f) {
  h = −i;
  h = 2.0 * f / g;
  if (j < 2) {
    j = (i + h) / g;
  }
}
```

Do statement 632 includes the keyword “do”, a statement, a Boolean expression 602 or a relational expression 614 enclosed in parentheses, the keyword “while”, and a semicolon. Do statement 632 is executed repeatedly while the expression is TRUE. The check is performed after each time Do statement 632 is executed, so the check is always performed at least once.

An example of Do statement 632 includes:

```
do {
  h = −i;
  h = 2.0 * f / g;
} while (f > g);
```

For statement 634 includes the keyword “for” and a statement that is executed for a predefined condition. In an embodiment, For statement 634 takes one of two forms. The first form is the C-like initial assignment, condition, and iteration. The second form iterates over the members of a set.

The first form has an initial assignment, a continuation condition, and an iteration assignment. The initial assignment is performed once before the loop statement is executed for the first time. The continuation condition is a Boolean expression 602, which is evaluated before each execution of the loop statement (including the first). The iteration assignment is performed after each execution of the loop statement. In an embodiment, the C-like form of For statement 634 takes the form:

ForStatement ::= for ( <identifier> = Expression ; Expression ;
<identifier> = Expression ) Statement ;

The second form of For statement 634 executes the loop statement once for each member of a specified set. During each iteration, the member is assigned to a specified variable. The variable must be of the same set type 416 as the elements of the set. In an embodiment, the second form of For statement 634 takes the form:

ForStatement ::= for ( <identifier1> = each <identifier2>
[ reverse ] in <identifier3> ) Statement ;

where “<identifier1>” names a variable of the type named in “<identifier2>”, which is the type of elements in “<identifier3>”. If the “reverse” keyword appears, the elements are enumerated in reverse order.

Examples of For statement 634 include:

for (i = 0; i < 5; i = i + 1) { }
for (a_stuff = each stuff in s1) { }
for (a_stuff = each stuff reverse in s1) { }
for (generic_stuff = each * in s1) { }
for (generic_stuff = each * reverse in s1) { }

A break statement 626 takes this form:

break;

Break statement 626 causes execution to jump to the statement following the end of the most closely nested while, do-while, or for loop.

A continue statement 628 takes this form:

continue;

Continue statement 628 causes execution to jump to the end of the most closely nested while, do-while or for loop. The loop checks its looping condition, and, if appropriate, loops again.

Return statement 630 takes this form:

return [Expression];

Return statement 630 causes script 302 to exit. Script 302 returns a value if and only if Returning Clause 310 was supplied. If script 302 returns a value, the value of the Expression 514 is returned. It is an error to fail to supply an Expression 514 if script 302 return a value, or to supply an Expression 514 if script 302 does not returns a value.

Place statement 636 adds a named object to a set. The object must have the same type 404 as the elements of the set, or the set must be generic. Place statement 636 can have a “before” or “after” clause, which affects where the new element is added. In an embodiment, place statement 636 takes the form:

PlaceStatement ::= place <identifier> into <identifier> [ ( before |
after) <identifier> ] ;

Examples of place statement 636 include:

place a_stuff into s1;
place a_stuff into s1 before b_stuff;
place b_stuff into s1 after a_stuff;

Remove statement 638 removes a named object from a set. The object must have the same type 404 as the elements of the set, or the set must be generic. In an embodiment, remove statement 638 takes the form:

RemoveStatement::=remove<identifier>from <identifier>;

Examples of remove statement 638 include:

remove a_stuff from s1;

A Returning Clause 310 comprises the keyword “returning” following by a Simple Type 412 or a String Type 414.

In an embodiment, the scripting language of the present invention is free form. Line breaks are not significant, except as white space. Comments can be embedded into script 302 and can take a similar form as comments embedded in the C++ or Java programming languages (i.e., double slash to end of line, or /* to */). Comments do not nest.

In an embodiment, several semantic checks are automatically executed prior to a script 302 being translated or interpreted (for example, at step 109 described above with reference to FIG. 1). For example, numeric string lengths must be greater than zero. If this condition is not true, an error report can be generated.

Variables can also be checked to ensure that they have been initialized before being used. Script 302 can also be checked to determine if a return value as been set, if appropriate. Script 302 can be checked to ensure that string initializers are not longer than the length declared for the string. Script 302 can be checked to ensure that an expression is in a return only if the script 302 returns a value. If the script 302 returns a value, its type should match the Returning Clause 310.

Script 302 can be checked to ensure that break statements 626 and continue statements 628 only occur inside a for, while, or do loop. Regarding a for loop, the continuation expression must be a Boolean expression 602. Regarding a for loop having the set form described above, the iteration variable must have same set type 416 as the set elements, including generic.

Script 302 can be checked to validate a place statement 636. An identifier in a place statement 636 must have the same set type 416 as the elements of the named set (or set is generic). If a before or after clause is used, the named element must have same type.

Script 302 can be checked to validate a set membership expression 610. The first and second identifiers in a set membership expression 610 must refer, respectively, to a variable of class type 418, and a set type 416.

Script 302 can be checked to validate a set selection expression 612. Identifiers in a set selection expression 612 must be class names or variables of the proper type 404, as appropriate. Retrieval keys must be known and of the correct type.

As discussed, a systems analyst is not required to have an understanding of the programming language or the software architecture of the underlying simulation model. To construct script 302, the systems analyst only needs to have an appropriate level of knowledge in the particular domain-specific field that is being simulated.

For example, air traffic control (ATC) is one potential domain for implementing the present invention. Typically, air traffic controllers communicate with the pilots of aircraft under their control exclusively by two-way voice radio. Even when airspace sectors are staffed by two controllers, only one controller (the “radar controller”) speaks to the aircraft, because the governing regulations do not permit the voice communications workload to be shared. Talking and listening on the radio constitute a large part of the radar controller's workload. This scheme limits the number of aircraft the radar controller can control at any given time, and limits the capacity of the airspace they control.

Establishing a digital data link represents an alternative scheme to using two-way radio. Resembling email or instant messaging, a data link would enable controllers to transmit text messages to the cockpits of aircraft under their control, and would greatly relieve the voice communications workload. In addition, a data link would allow the second controller (the “data controller”) to conduct some communications and share the workload with the radar controller.

Data link communications would be very expensive to implement, as it would require extensive changes to the ground-based communications infrastructure, and equipage of virtually every aircraft with data link equipment. Before committing the large sums of money required for implementation, it is necessary to establish the benefits of such a system. A computer simulation can be developed to estimate the potential benefits of proposed technologies such as a data link.

An ATC simulation model can be developed to represent airspace capacity as a simple maximum aircraft count. When, during a simulation run, the maximum aircraft count has been determined to be exceeded, the simulation model delays any additional flights until some other flights have left the sector in question. Conventionally, a developer (having expertise in the programming language used to build the simulation model) must re-program the simulation model to modify the actions that take place inside the model. To use the simulation model to analyze the data link alternative discussed above, it would therefore be necessary first to conduct a separate manual analysis of the impact of a data link on the maximum aircraft count, and only then simulate the impact of the data link by changing the maximum aircraft count values in the simulation model. A systems analyst working in the ATC domain would not be able to make these modification, unless the analyst was skilled in the simulation programming language and the software architecture of the simulation model. This greatly limits the utility and accuracy of conventional simulation models.

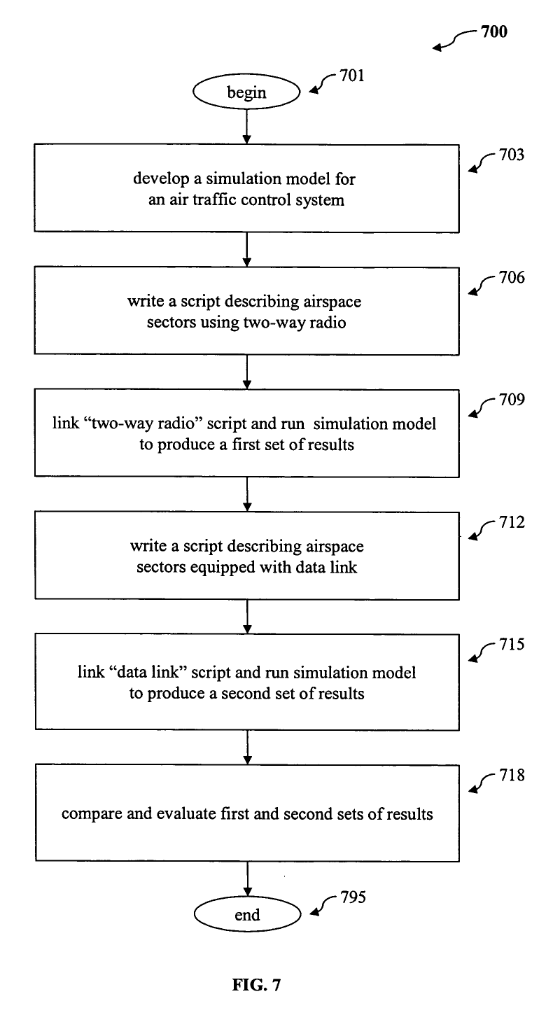

Referring back to FIG. 2, domain-specific scripting system 200 addresses these concerns by providing scripts (e.g., script 302) that describe the behavior (e.g., actions and functions) of all relevant entities, including airspace sectors. Scripting system 200 allows a systems analyst to modify the behavior of the model by changing one or more scripts 302 to reflect changes the systems analyst wishes to study, and without having to understand the programming language and the software architecture of the underlying simulation model. To analyze the effectiveness and efficiency of using two-way radio communications versus a data link (as discussed above), a systems analyst can write one or more scripts 302 to run a simulation as illustrated in FIG. 7.

Referring to FIG. 7, flowchart 700 represents the general operational flow of an embodiment of the present invention for running a script-based simulation. More specifically, flowchart 700 shows an example of a control flow for evaluating behavior changes (i.e., using two-radio versus a data link) to an ATC simulation model.

The control flow of flowchart 700 begins at step 701 and passes immediately to step 703. At step 703, an ATC simulation model (e.g., simulation model code 208) is designed and developed by a developer.

At step 706, a systems analyst prepares a script (e.g., script 302) that describes the action of an airspace sector using two-way radio during the tasks performed by a radar controller. The “two-way radio” script also describes the amount of time required to perform each task. In an embodiment, the two-way radio script can be the default script definitions (e.g., script definitions 204a-204n) developed for the underlying simulation model (e.g., simulation code 208). In this case, the systems analyst would accept the default script definitions without making any modifications (e.g., preparing new script definitions 204a-204n). In another embodiment, the systems analyst writes or modifies one or more script definitions (204a-204n) to modify a generic script specification (e.g., script specifications 202a-202n) to prepare the two-way radio script.

At step 709, the two-way radio script is linked or combined with the underlying ATC simulation model. The simulation model is compiled and executed to produce a set of results or metrics describing the performance of the simulated ATC system. In an embodiment, the metrics include delay, throughput, and other relevant measures.

At step 712, the systems analyst prepares a script (e.g., script 302) that describes the action of an airspace sector equipped with a data link. The “data link” script differs from the two-way radio script in the tasks the controller performs and the time each task takes. In addition to writing a script to describe the tasks performed by the controller, it is also possible to write a script for the aircraft to describe their behavior when the aircraft is equipped with data links. However, this is not strictly necessary if one assumes that all aircraft are equipped.

At step 715, the data link script is linked or combined with the underlying ATC simulation model. Upon execution, a second set of results or metrics are produced to describe the performance of the ATC system. As described at step 709 in an embodiment, the metrics include delay, throughput, and other relevant measures.

At step 718, the two simulation runs are compared and evaluated. Thus, an analysis of data link benefits takes place in two phases: baseline and treatment. In the baseline phase (i.e., steps 706-709), the performance of the ATC system is computed using the two-way radio script that describes airspace operations having two-way radio. Metrics describing the performance includes delay, throughput, and other relevant measures. Typically, the baseline phase run is conducted using air traffic demand data for the future time frame in which the data link is expected to be available. In other words, the baseline phase describes the future performance of the ATC system without data link.

In the treatment phase, the same traffic demand data is used, but a revised script reflecting operation of airspace equipped with the data link is substituted. The ATC simulation model is run again, and the performance metrics are compared to the baseline results. The differences in delay, throughput and other metrics are tabulated, and typically expressed as a dollar value (i.e., the dollar value of the reduced delay and enhanced throughput brought about by the introduction of data link). Such results allow systems analysts to compare the benefits of the data link to project costs, and compute a benefit/cost ratio.

Upon completion of the evaluation step, the control flow ends at step 795. As described, an embodiment of the present invention (e.g., domain-specific scripting system 200) allows a systems analyst to modify an ATC simulation model that supports scripted definitions of the behavior of modeled entities. The above control flow provides an example of scripts being used to conduct analyses relevant to the enhancement of the National Airspace System.

Another example of a script (e.g., 302) that can be used to modify the behavior of a simulation model and analyze an ATC domain is provided below:

```
script taxi_out(
  time_t pushback_time,
  airport_t the_airport,
  runway_t the_runway) returning time_t
{
  int taxiing_count;
  int congestion_param;
  time_t nominal_taxi;
  time_t delay_param;
  taxiing_count = the_airport.instantaneous_taxi_count( );
  congestion_param = the_airport.congestion( );
  nominal_taxi = the_airport.nominal_taxi_time(the_runway);
  delay_param = the_airport.delay_param( );
  if (taxiing_count > congestion_param) {
    return nominal_taxi + delay_param;
  }
  else {
    return nominal_taxi;
  }
}
```

The above script is explained with reference back to FIGS. 2-6. The above script is named “taxi_out” as indicated by the script identifier 304. Script “taxi_out” can be linked or combined with an ATC simulation model to describe the performance of an ATC system and evaluate modifications in the amount of time departing aircrafts must wait on the ground before they can “taxi out” for takeoff.

Following the script identifier 304 are the formal arguments 306 for script “taxi_out” and a Returning Clause 310. The formal arguments 306 include an ordered list of types 404 and a return type 404. The ordered list includes three class types 418 declared as “time_t”, “airport_t”, and “runway t”. The three class types 418 are followed by identifiers for three input variables “pushback_time”, “the_airport”, and “the_runway”, respectively. These variable identifiers are later referenced in the following script statements (of the script body 308 described below), and are therefore linked with a corresponding class type 418. The class types 418 are translated into pointer-to-class types that are used by the simulation model code (e.g., simulation model code 208).

The return type is also declared as class type 418, as indicated by “time_t”. The return type is also translated into a pointer-to-class types when script “taxi_out” is combined with the simulation model code.

Following the formal arguments 306 is the script body 308. The first four lines in the script body 308 are declarations 502. The first two declarations 502 are simple declarations 506. As shown, the variables having the identifiers “taxiing_count” and “congestion_parameter” are both declared as simple “integer” types 412

The second two declarations 502 are class declarations 508. The variables having the identifiers “nominal_taxi” and “delay_param” are both declared class types 418. To declare the variables as class types, the variables are associated with the type “time_t” that is stated in the formal argument 306.

Following the declarations 502 are the assignment statements 504 for the script body 308. The assignment statements 504 in script “taxi out” include four method calls 608 and an If statement 622. More specifically, the first assignment statement 504 begins with an assignment identifier 512 having the variable name “taxiing_count”. As discussed, the variable “taxiing_count” is declared as a simple integer type 412 in the declarations 502. The variable “taxiing_count” is defined by a method call expression 608, which includes a procedure call 606 identified by “instantaneous_taxi_count( )” that is proceeded by a dot and the identifier “the_airport” that is a class type 418 (as designated in the formal argument 306). The argument(s) for “instantaneous_taxi_count” would be presented in the parenthetical list “( )”, which is blank above for illustrative purposes.

Similarly, the variable “congestion_param” is a simple integer type 412, and is defined by a method call expression 608. Expression 608 includes a procedure call 606 identified by “congestion( )” that is proceeded by a dot and the identifier “the_airport” that is a class type 418.

The variable “nominal_taxi” is declared as a class type 418 in the declarations 502. The variable “nominal_taxi” is defined by a method call expression 608. Expression 608 includes a procedure call 606 identified by “nominal_taxi_time (the_runway)” that is proceeded by a dot and the identifier “the_airport” that is a class type 418.

Finally, the variable “delay_param” is declared as a class type 418. The variable “delay_param” is defined by a method call expression 608. Expression 608 includes a procedure call 606 identified by “delay_param( )” that is proceeded by a dot and the identifier “the_airport” that is a class type 418.

The If statement 622 includes a basic branch that contains a Boolean expression 602. The Boolean expression 602 determines the truth of the expression “taxiing_count>congestion_param”. If the expression is true, the return variable “time_t” is “nominal_taxi+delay_param”. Otherwise, the return variable “time_t” is “nominal_taxi”.

Script “taxi_out” allows a systems analyst to modify the script body 308 and evaluate changes to the taxi-out time for ground aircraft. The script body 308 establishes a congestion parameter (i.e., “congestion_param”) that indicates a maximum number of aircraft that should be queued for takeoff. The script body 308 also provides procedures for determining the projected number of aircraft queued for takeoff (i.e., “taxiing_count”) based on specified actions and functions performed during the simulation. As long as the number of aircraft queued for takeoff (i.e., “taxiing_count”) does not exceed the congestion parameter (i.e., “congestion_param”), the taxi-out time is determined from procedures used to update the variable “nominal_taxi”. Otherwise, procedures are executed to determine a delay parameter (i.e., “delay_param”). The delay parameter is added to the variable “nominal_taxi” to determine a taxi-out time to relieve the congestion.

Instead of using a congestion parameter, the systems analyst can revise script “taxi_out” to compute the taxi-out time from other factors, including, for example, the distance to a gate, aircraft size, aircraft speed, or the like. The systems analyst can revise the script to modify the simulation behavior (e.g., the specific tasks, actions, functions, etc.) and evaluate the effects on the simulation run (i.e., the taxi-out time). To make these modifications, the systems analyst must have the appropriate level of knowledge in air traffic control, but, as discussed above, does not have to be an expert in the programming language and/or the software architecture of the underlying simulation model.

FIGS. 1-7 are conceptual illustrations allowing an explanation of the present invention. It should be understood that various aspects of embodiments of the present invention could be implemented in hardware, firmware, software, or a combination thereof. In such an embodiment, the various components and steps would be implemented in hardware, firmware, and/or software to perform the functions of the present invention. That is, the same piece of hardware, firmware, or module of software could perform one or more of the illustrated blocks (i.e., components or steps).

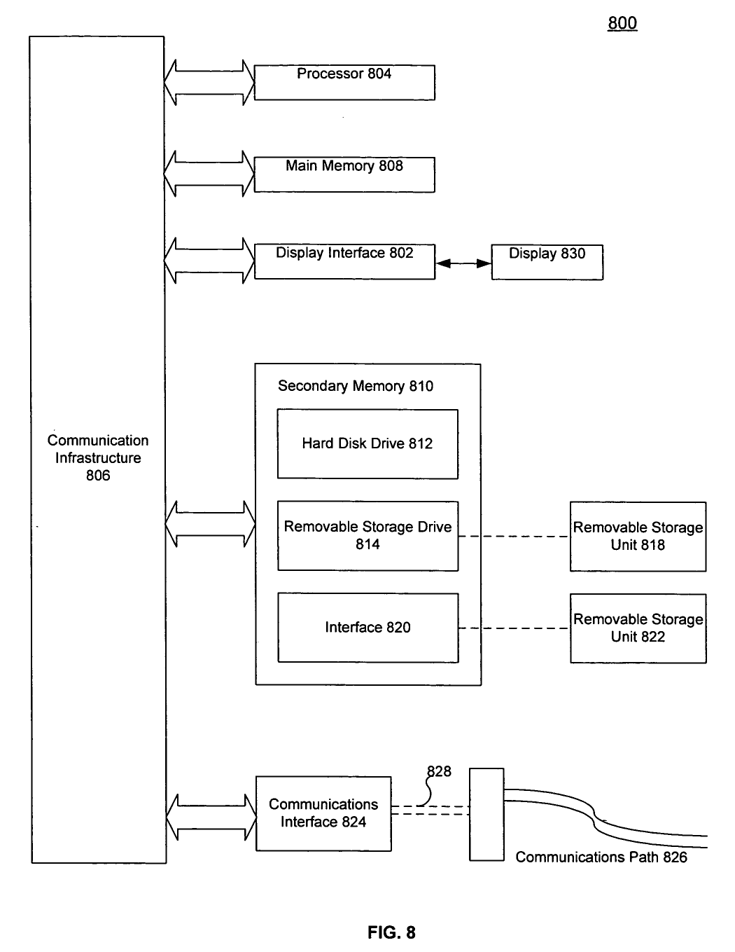

The present invention can be implemented in one or more computer systems capable of carrying out the functionality described herein. Referring to FIG. 8, an example computer system 800 useful in implementing aspects of the present invention is shown. Various embodiments of the invention are described in terms of this example computer system 800. After reading this description, it will become apparent to one skilled in the relevant art(s) how to implement the invention using other computer systems and/or computer architectures.

The computer system 800 includes one or more processors, such as processor 804. The processor 804 is connected to a communication infrastructure 806 (e.g., a communications bus, crossover bar, or network).

Computer system 800 can include a display interface 802 that forwards graphics, text, and other data from the communication infrastructure 806 (or from a frame buffer not shown) for display on the display unit 830.

Computer system 800 also includes a main memory 808, preferably random access memory (RAM), and can also include a secondary memory 810. The secondary memory 810 can include, for example, a hard disk drive 812 and/or a removable storage drive 814, representing a floppy disk drive, a magnetic tape drive, an optical disk drive, etc. The removable storage drive 814 reads from and/or writes to a removable storage unit 818 in a well-known manner. Removable storage unit 818, represents a floppy disk, magnetic tape, optical disk, etc. which is read by and written to removable storage drive 814. As will be appreciated, the removable storage unit 818 includes a computer usable storage medium having stored therein computer software (e.g., programs or other instructions) and/or data.

In alternative embodiments, secondary memory 810 can include other similar means for allowing computer software and/or data to be loaded into computer system 800. Such means can include, for example, a removable storage unit 822 and an interface 820. Examples of such can include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to computer system 800.

Computer system 800 can also include a communications interface 824. Communications interface 824 allows software and data to be transferred between computer system 800 and external devices. Examples of communications interface 824 can include a modem, a network interface (such as an Ethernet card), a communications port, a PCMCIA slot and card, etc. Software and data transferred via communications interface 824 are in the form of signals 828 which can be electronic, electromagnetic, optical, or other signals capable of being received by communications interface 824. These signals 828 are provided to communications interface 824 via a communications path (i.e., channel) 826. Communications path 826 carries signals 828 and can be implemented using wire or cable, fiber optics, a phone line, a cellular phone link, an RF link, free-space optics, and/or other communications channels.

In this document, the terms “computer program medium” and “computer usable medium” are used to generally refer to media such as removable storage unit 818, removable storage unit 822, a hard disk installed in hard disk drive 812, and signals 828. These computer program products are means for providing software to computer system 800. Aspects of the present invention are directed to such computer program products.

Computer programs (also called computer control logic or computer readable program code) are stored in main memory 808 and/or secondary memory 810. Computer programs can also be received via communications interface 824. Such computer programs, when executed, enable the computer system 800 to implement the present invention as discussed herein. In particular, the computer programs, when executed, enable the processor 804 to implement the processes of the present invention, such as the various steps of methods 100 and 700, for example, described above. Accordingly, such computer programs represent controllers of the computer system 800.

In an embodiment where the invention is implemented using software, the software can be stored in a computer program product and loaded into computer system 800 using removable storage drive 814, hard drive 812, interface 820, or communications interface 824. The control logic (software), when executed by the processor 804, causes the processor 804 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to one skilled in the relevant art(s).

In yet another embodiment, the invention is implemented using a combination of both hardware and software.

The foregoing description of the specific embodiments will so fully reveal the general nature of the invention that others can, by applying knowledge within the skill of the art (including the contents of the documents cited and incorporated by reference herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the art.

While various embodiments of the present invention have been described above, it should be understood that they have been presented by way of example, and not limitation. It will be apparent to one skilled in the relevant art(s) that various changes in form and detail can be made therein without departing from the spirit and scope of the invention. Thus, the present invention should not be limited by any of the above-described exemplary embodiments, but should be defined only in accordance with the following claims and their equivalents.

What is claimed is:

1. A method of managing a simulation model of a specific domain, comprising the steps of:
preparing a domain-specific script to define or change a behavior of the simulation model; and
combining the domain-specific script with simulation code for the simulation model, whereby the domain-specific script introduces one or more commands to the simulation code to manage the behavior of the simulation model.

2. The method according to claim 1, wherein said preparing step comprises the step of:
specifying an input variable or an output variable in the domain-specific script.

3. The method according to claim 2, wherein said preparing step further comprises the step of:
associating the input variable or the output variable to a class type declared in the simulation code for the simulation model.

4. The method according to claim 1, wherein said preparing step comprises the step of:
specifying a command or procedure that, when executed, produces a simulated outcome.

5. The method according to claim 1, wherein said preparing step comprises the step of:
accessing a script specification having information for defining script boundaries for preparing the domain-specific script.

6. The method according to claim 5, wherein said preparing step further comprises the step of:
preparing a script definition to accept or replace a default definition from the script specification.

7. The method according to claim 6, wherein said preparing step comprises the step of:
matching the script definition with the script specification to produce the domain-specific script.

8. The method according to claim 1, wherein said combining step comprises the step of:
translating the domain-specific script into a sequence of simulation code, whereby the sequence of simulation code is combined with the simulation code for the simulation model.

9. The method according to claim 1, wherein said combining step comprises the step of:
compiling the combined domain-specific script and simulation code into executable code for running the simulation model.

10. The method according to claim 1, further comprising the steps of:
preparing a second domain-specific script to define or modify an alternative behavior of the simulation model; and
combining the second domain-specific script with simulation code of the simulation model.

11. The method according to claim 10, further comprising the steps of:
executing the first combination of domain-specific code and simulation code to produce a first outcome from the simulation model; and
executing the second combination of the second domain-specific script and simulation code to produce a second outcome from the simulation model.

12. The method according to claim 11, further comprising the step of:
evaluating the first outcome and the second outcome.

13. A system for manipulating or changing a simulation model of a specific domain, comprising:
scripting means for accessing a domain-specific script, wherein said domain-specific script includes a sequence of commands for defining or changing a behavior of the simulation model; and
a configuration tool adapted to combine said domain-specific script with simulation code for the simulation model to produce a modified simulation code, wherein said modified simulation code, when executed, manipulates or changes the behavior of the simulation model.

14. The system of claim 13, further comprising:
a script parser adapted to translate said domain-specific script into a sequence of simulation code, wherein said sequence of simulation code is combined with said simulation code to produce said modified simulation code.

15. The system of claim 13, wherein said configuration tool is further adapted to match a script definition with a script specification to produce said domain-specific script, wherein said script specification includes information for defining script boundaries for said domain-specific script, wherein said script definition includes instructions for accepting or rejecting a default definition corresponding to said script specification.

16. A computer program product comprising a computer useable medium having computer readable program code functions embedded in said medium for causing a computer to manipulate or change a simulation model, comprising:
a first computer readable program code function that causes the computer to access a domain-specific script, wherein said script includes a sequence of commands for defining or changing a behavior of the simulation model; and
a second computer readable program code function that causes the computer to combine said domain-specific script with simulation code for the simulation model to produce a modified simulation code, wherein said modified simulation code, when executed, manipulates or changes the behavior of the simulation model.

17. The computer program product according to claim 16, further comprising:
a third computer readable program code function that causes the computer to translate said domain-specific script into a sequence of simulation code, wherein said sequence of simulation code is combined with said simulation code to produce said modified simulation code.

18. The computer program product according to claim 16, further comprising:
a third computer readable program code function that causes the computer to match a script definition with a script specification to produce said domain-specific script, wherein said script specification includes information for defining script boundaries for said domain-specific script, wherein said script definition includes instructions for accepting or rejecting a default definition corresponding to said script specification.
